(19) United States
(12) Patent Application Publication
(10) Pub. No.: US 2008/0259746 A1
(43) Pub. Date: Oct. 23, 2008

(54) METHOD OF MANAGING PLAYLIST BY USING KEY

(75) Inventor: Yong-seok JANG, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/873,598

(22) Filed: Oct. 17, 2007

(30) Foreign Application Priority Data
Apr. 20, 2007 (KR) 10-2007-0038980

(51) Int. Cl. G11B 7/085

(52) U.S. Cl. 369/30.09

(57) ABSTRACT

Provided is a method of managing a playlist. In an environment in which a content is being reproduced in a contents reproducing apparatus, it is possible to create a playlist according to a user's preference or to reproduce contents conveniently with a single input of a number key without going through several operations, thereby improving user convenience when reproducing contents.

### CROSS-REFERENCE TO RELATED PATENT APPLICATIONS

This application claims priority from Korean Patent Application No. 10-2007-0038980, filed on Apr. 20, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to managing a playlist, and more particularly, to managing a contents playlist by using a key of a portable apparatus for reproducing contents.

2. Description of the Related Art

Recently, music is commonly reproduced using a portable apparatus for reproducing contents, for example, a mobile phone, a Moving Pictures Experts Group (MPEG) Audio Layer-3 (MP3) player, and the like. Also, since memory capacity of portable apparatuses for reproducing contents has increased, the number of music files which can be stored has increased accordingly. Therefore, there is a need to manage a huge amount of music files stored in portable apparatuses for reproducing contents, by proper grouping according to a user's preference, or a music genre.

However, when contents are reproduced in a mobile phone, a playlist is made by specific software which is provided from a mobile phone manufacturer or a contents providing company and then downloaded to the mobile phone. Otherwise, a user has to go through several operations to reproduce contents in a mobile phone without making a playlist.

In the case of using an MP3 player, a user makes a playlist file, which the MP3 player supports, in a Personal Computer (PC) and downloads the playlist to the MP3 player. However, it is not yet possible to make a desired playlist by using the MP3 player while a content is being reproduced in the MP3 player.

In other words, in a present environment for portable apparatuses for reproducing contents, it is difficult to register a content with a playlist while the content is being reproduced and a user has to go through several operations to create or select a playlist to reproduce contents.

### SUMMARY OF THE INVENTION

The present invention provides a method of creating a playlist according to a user's liking or conveniently reproducing contents, with a single input of a number key without going through several operations during reproduction of a content in a contents reproducing apparatus, thereby improving user convenience when reproducing contents.

According to an aspect of the present invention, there is provided a method of managing a playlist by using a key of a contents reproducing apparatus, the method including: reproducing a predetermined content in the contents reproducing apparatus; inputting a predetermined key during reproduction of the content; and registering the content being reproduced with a playlist corresponding to the key.

According to another aspect of the present invention, there is provided a method of managing a playlist by using a key of a contents reproducing apparatus, the method including: reproducing a predetermined content in the contents reproducing apparatus; displaying a menu associated with a playlist according to an input of a menu button of the contents reproducing apparatus; and inputting a predetermined key, and managing a playlist corresponding to the input key according to the menu associated with the playlist.

According to another aspect of the present invention, there is provided a recording medium having recorded thereon a program for executing the above methods using a computer.

### BRIEF DESCRIPTION OF THE DRAWINGS

The above and other aspects of the present invention will become more apparent by describing in detail exemplary embodiments thereof with reference to the attached drawings in which:

FIG. 1 is a schematic block diagram of a contents reproducing apparatus according to an exemplary embodiment of the present invention;

FIG. 2 is a flowchart illustrating a method of registering contents with a playlist by using a number key according to another exemplary embodiment of the present invention;

FIG. 3 is a flowchart illustrating a method of registering contents with a playlist by using a number key according to another exemplary embodiment of the present invention; and

FIG. 4 is a flowchart illustrating a method of managing a playlist by using a number key according to another exemplary embodiment of the present invention.

### DETAILED DESCRIPTION OF EXEMPLARY EMBODIMENTS

The present invention will now be described more fully with reference to the accompanying drawings, in which exemplary embodiments of the invention are shown.

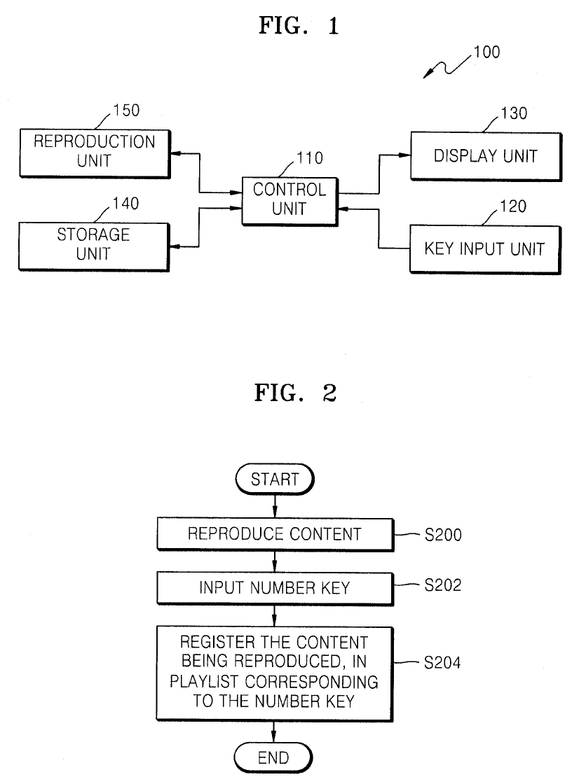

FIG. 1 is a schematic block diagram of a contents reproducing apparatus 100 according to an exemplary embodiment of the present invention.

Referring to FIG. 1, the contents reproducing apparatus 100 includes a control unit 110, a key input unit 120, a display unit 130, a storage unit 140, and a reproduction unit 150. For convenience of explanation, FIG. 1 illustrates only elements of the content reproducing apparatus 100 that are essential for implementing the current exemplary embodiment. However, the content reproducing apparatus 100 actually includes all elements of a general contents reproducing apparatus.

The contents reproducing apparatus 100 includes common apparatuses for reproducing music, such as a mobile phone having a contents reproducing function, and an MPEG Audio Layer-3 (MP3) player, and the like. Here, contents include MP3 music files, and the like.

The control unit 110 performs overall control of the contents reproducing apparatus 100 and in particular, controls overall operations for managing a playlist by using a number key according to an exemplary embodiment of the present invention. According to a user's command to reproduce contents, which is input via the key input unit 120, the control unit 110 extracts a content stored in the storage unit 140 and provides the content to the reproduction unit 150 so as to enable the content to be reproduced. Also, the control unit 110 receives a specific number key, e.g., 0 through 9, via the input unit 120, and searches the storage unit 140 which stores a playlist corresponding to the specific number key. When the playlist corresponding to the specific number key does not exist in the storage unit 140, the control unit 110 controls a new playlist to be created. When a menu button is input to the control unit 110 via the key input unit 120, the control unit 110 provides a menu associated with a playlist to the display unit 130. Here, the menu associated with the playlist includes reproducing contents which exist in the playlist corresponding to the specific number key, registering a content being reproduced through the reproduction unit 150 with the playlist corresponding to the specific number key, and deleting the content being reproduced.

The key input unit 120 receives a user's command via a key button of the contents reproducing apparatus 100. According to an exemplary embodiment of the present invention, the key input unit 120 may receive a user's command via number key button including 0 through 9, a menu button, or a play button, and provide the user's command to the control unit 110.

The display unit 130 performs a function of displaying a playlist, contents information, a present state of the contents reproducing apparatus 100, etc., and may be formed using a liquid crystal display (LCD).

The storage unit 140 stores contents, playlists, etc., and may be formed using various kinds of memories.

The reproduction unit 150 performs a function of reproducing the contents stored in the storage unit 140.

FIG. 2 is a flowchart illustrating a method of registering contents with a playlist by using a number key according to another exemplary embodiment of the present invention.

Referring to FIG. 2, in operation 200, the contents reproducing apparatus 100 reproduces a specific content. In operation 202, a specific number key selected by a user is input during reproduction of the content. Here, the specific number key is a key button having 0 through 9, and may be realized by pressing the specific number key over a predetermined time. In operation 204, the content being reproduced, is registered with the playlist corresponding to the specific number key. Thus, a user can create a playlist according to the user's liking without going through several operations, in even an environment in which a content is being reproduced in a contents reproducing apparatus.

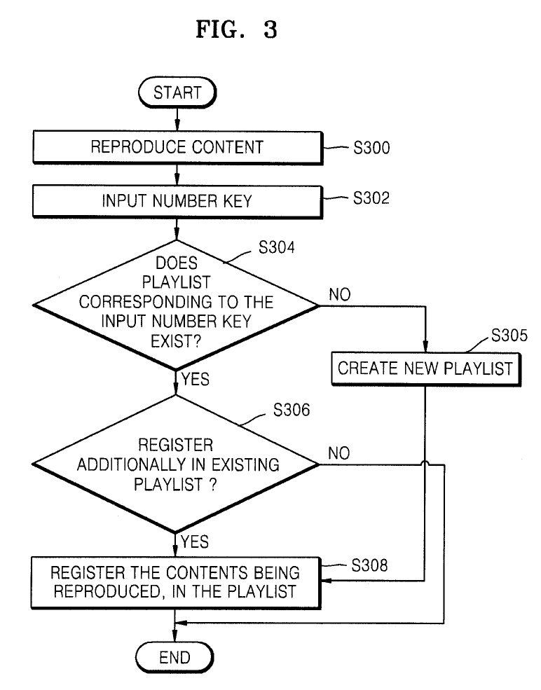

FIG. 3 is a flowchart illustrating a method of registering contents with a playlist by using a number key, according to another exemplary embodiment of the present invention.

Referring to FIG. 3, in operation 300, the contents reproducing apparatus 100 reproduces a specific content. In operation 302, a specific number key selected by a user is input during reproduction of the content. Operations 300 and 302 are identical to operations 200 and 202, which are shown in FIG. 2.

In operation 304, searching is performed to determine whether a playlist corresponding to the specific number key selected by the user exists in the storage unit 140. In operation 306, if it is determined in operation 304 that the playlist exists, the user is asked whether to additionally register the content with the existing playlist. If the user wants to additionally register the content, the content being reproduced, is further registered with the existing playlist corresponding to the selected specific number key in operation 308.

As a result of operation 304, when it is determined that the playlist does not exist, a new playlist corresponding to the specific number key selected by the user is created in operation 305. After that, the content being reproduced is registered with the newly created playlist in operation 308.

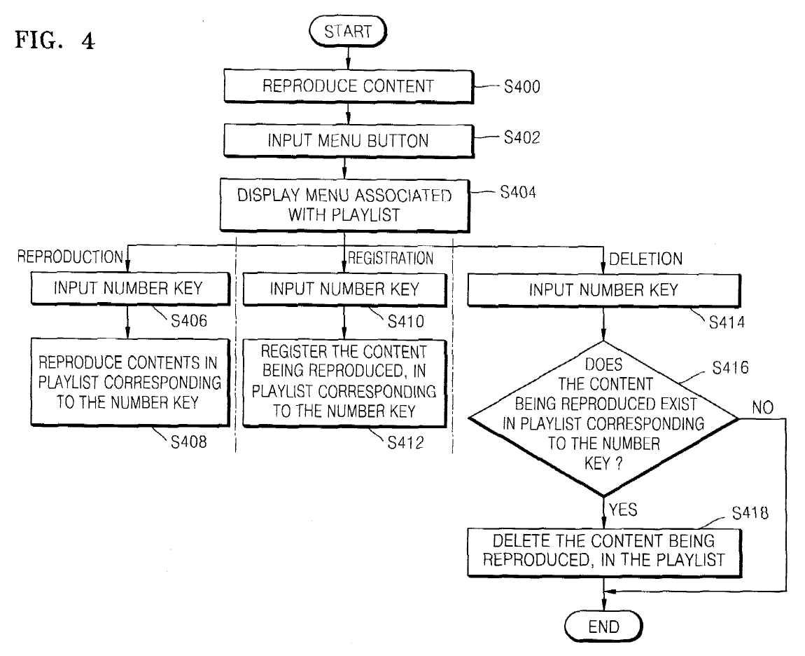

FIG. 4 is a flowchart illustrating a method of managing a playlist by using a number key according to another exemplary embodiment of the present invention.

Referring to FIG. 4, the contents reproducing apparatus 100 reproduces a specific content in operation 400. Then, a user selects a menu button of the contents reproducing apparatus 100 in operation 402 so that a menu associated with a playlist is displayed on a screen of the contents reproducing apparatus 100 in operation 404. Here, the menu associated with a playlist includes reproducing contents which exist in a playlist corresponding to a number key; registering the content being reproduced, with a playlist corresponding to a number key; and deleting the content being reproduced.

When the menu for contents reproduction is selected by a user, a specific number key is input in operation 406, and contents which exist in a playlist corresponding to the specific number key are reproduced in operation 408. Therefore, when a user inputs a number key during reproduction of the specific content as in the above operation 400, contents which exist in a playlist corresponding to the number key, can be conveniently reproduced.

When the menu for playlist registration is selected by a user, a specific number key is input in operation 410 so that the content being reproduced is additionally registered with a playlist corresponding to the specific number key in operation 412. Also, as another option, when a playlist corresponding to the specific number key does not exist, a new playlist is created so that the content may be registered thereto.

When the menu for playlist deletion is selected by a user, a specific number key is input in operation 414 so that searching is performed to determine whether the content being reproduced exists in a playlist corresponding to the specific number key in operation 416. When the content being reproduce, exists in the playlist corresponding to the specific number key, the content being reproduced is deleted from the playlist in operation 418. Therefore, a user can manage playlists by proper grouping according to a user's preference, or a music genre.

In an environment in which a content is being reproduced in a contents reproducing apparatus, the present invention can create a playlist according to a user's preference or reproduce contents conveniently with a single input of a number key without going through several operations, thereby improving user convenience when reproducing contents.

The present invention can be embodied as computer-readable code on a computer-readable recording medium. The computer-readable recording medium is any data storage device that can store data, which can be thereafter read by a computer system.

Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing a playlist by using a key of a contents reproducing apparatus, the method comprising:
reproducing a content in the contents reproducing apparatus;
inputting a first key during the reproducing of the content; and
registering the content being reproduced with a playlist corresponding to the first key.

2. The method of claim 1, further comprising:
determining whether the playlist corresponding to the first key exists after the inputting of the first key; and
determining whether the content being reproduced is to be registered with the playlist if it is determined that the playlist corresponding to the first key exists.

3. The method of claim 2, further comprising:
creating the playlist corresponding to the first key if it is determined that the playlist corresponding to the first key does not exist; and
registering the content being reproduced with the created playlist.

4. The method of claim 1, further comprising:
inputting a menu button after the reproducing of the content; and
displaying a menu associated with the playlist according to the input menu button.

5. The method of claim 4, wherein the menu associated with the playlist comprises at least one of:
playlist reproduction which reproduces of a content in a playlist corresponding to a second key;
playlist registration which registers the content being reproduced with the playlist corresponding to the first key; and
playlist deletion which deletes the content being reproduced from the playlist corresponding to the first key.

6. The method of claim 1, wherein the first key comprises number keys 0 through 9.

7. A method of managing a playlist by using a key of a contents reproducing apparatus, the method comprising:
reproducing a content in the contents reproducing apparatus;
displaying a menu associated with a playlist according to an input of a menu button of the contents reproducing apparatus; and
inputting a key, and managing a playlist corresponding to the input key according to the menu associated with the playlist.

8. The method of claim 7, wherein the managing of the playlist comprises reproducing a content in the playlist corresponding to the input key.

9. The method of claim 7, wherein the managing of the playlist comprises registering the content being reproduced with the playlist corresponding to the input key.

10. The method of claim 9, wherein if the playlist corresponding to the input key does not exist, the managing of the playlist comprises creating the playlist corresponding to the input key, and registering the content being reproduced with the created playlist.

11. The method of claim 7, wherein the managing of the playlist comprises deleting the content being reproduced from the playlist corresponding to the input key.

12. The method of claim 11, wherein the managing of the playlist further comprises:
determining whether the content being reproduced exists in the playlist corresponding to the input key; and
deleting the content being reproduced from the playlist corresponding to the input key, if the content being reproduced exists in the playlist corresponding to the input key.

13. The method of claim 7, wherein the key comprises number keys 0 through 9.

14. A recording medium having recorded thereon a program for executing the method of claim 1 on a computer.

15. A recording medium having recorded thereon a program for executing the method of claim 7 on a computer
